(19) United States
(12) Patent Application Publication
(10) Pub. No.: US 2009/0229234 A1
(43) Pub. Date: Sep. 17, 2009

(54) Apparatus for clearing up, in particular removing sand from, areas of grass

(76) Inventor: Hans-Juergen Ettrich, Dossenheim (DE)

Correspondence Address: JORDAN AND HAMBURG LLP, 122 EAST 42ND STREET, SUITE 4000, NEW YORK, NY, 10168, US

(21) Appl. No.: 11/988,884

(22) PCT Filed: Jul. 10, 2006
(86) PCT No.: PCT/EP2006/006720

§ 371 Date: Jan. 14, 2008

(30) Foreign Application Priority Data
Jul. 15, 2005 (DE) 202005017163.8
Nov. 2, 2005 (DE) 202005017238.3

(51) Int. Cl. A01D 51/00

(52) U.S. Cl. 56/13.1

(57) ABSTRACT

An apparatus for clearing up, in particular for removing sand from, areas of grass includes a basic housing, rollers, a blower and a collection container. The apparatus has a low degree of design complexity such that areas of grass can be cleared up in a simple manner, it being possible, in particular, to easily remove sand and other foreign matter from greens of golf courses. The invention proposes providing a nozzle, through which the propelled air which is conveyed by means of the blower flows towards the area of grass, downstream of the blower in the direction of flow, wherein no cutting tool is provided. An inflow opening of an exhaust-air duct is arranged downstream of the nozzle, with a space being left free above the area of grass, in such a way that the air flows substantially horizontally over the area of grass in the space. A guide element which can be made to rest on the area of grass is provided in the region of the inflow opening, wherein the exhaust-air duct issues into the collection container for holding the sand and/or foreign matter which is removed from the area of grass.

### BACKGROUND OF THE INVENTION

The invention relates to an apparatus for cleaning up grassy areas, in particular for removing sand from grassy areas.

Such an apparatus is known from DE 196 35 310 A1, in accordance with which, it is embodied as a lawnmower having a cutting tool that rotates about a vertical axis. Arranged on the shaft of the cutting tool above the latter is a fan with the suction side in the direction toward the working area of the cutting tool. The grass that has been mowed by the cutting tool and debris that is present thereupon are suctioned by means of the fan and transported into a collection container. In addition, however, dirt or sand can be removed from the ground of a grassy area and transported in an undesired manner into the collection container.

Stringent demands are imposed on golf courses in terms of the quality of the green, precisely cut grass of a specific length being just as important as a uniform base or as the ground having a uniform surface. Therefore, in caring for the green, sand is usefully added after the grass is cut and/or prior to tournaments in order to level or even out irregularities, undulations, holes, or the like. However, some of the sand remains trapped in the grass so that when the grass is cut again the cutting tool of a lawnmower dulls rapidly due to the hardness of the special sand that was used, and the cutting tool must be sharpened frequently because otherwise it is not possible to attain the best possible mowing of the green. The caretaking normally required in the past after sand was applied to the green has been very labor and time-intensive.

Furthermore, known from U.S. Pat. No. 5,317,860 is another apparatus embodied as a lawnmower that has a cutting tool and a fan with a nozzle that is downstream in the direction of flow for collecting the cut material. The nozzle is arranged such that the stream of air is blown onto the grassy area quite steeply from above so that particles, in particular sand, that are much heavier compared to the cut material or the mowed grass cuttings are blown downward onto the ground or into the lawn, and not removed.

Proceeding from this known state of the art, the underlying object of the invention is to embody an apparatus of the aforementioned type such that it is effective for cleaning up grassy areas with low complexity, and in particular, to remove sand and other debris from greens with out problem. The apparatus should be as gentle with the green as possible. Moreover, the apparatus should be embodied for removing pellets after aeration as well as sand, leaves, or other foreign matter from the green. Furthermore, the apparatus should have a simple and functionally appropriate structure and should facilitate simple handling.

### SUMMARY OF THE INVENTION

The apparatus according to the invention is distinguished by a simple and functionally appropriate design, and facilitates the removal of excess sand from the grassy area or the green with no problem, especially after aeration. Since the grassy area or the green is not subjected to suction by means of the apparatus but rather is subjected to an air stream produced by means of a fan, the material, such as in particular the excess sand or other debris, is blown away and transported into the collection container, and the sand also remains primarily and reliably in the holes, irregularities, and the like already present in the ground. In contrast to the lawnmowers cited in the foregoing disclosures, the apparatus according to the invention does not contain a cutting tool, but rather, the air stream produced by means of the fan is blown across the green, in particular by a nozzle oriented in a pre-specified direction onto the surface of the green, and excess sand and other foreign matter or particles of debris are blown off of the grass by means of the defined pre-specified air stream. The inventive apparatus is embodied solely for removing sand or other foreign matter from the lawn surface, in particular greens on golf courses. The air stream transported out of the nozzle by means of the fan is conducted at a comparatively small angle onto the grassy area and passes thereover at least approximately tangentially in the free space between the nozzle and an exhaust air channel.

In the inlet area, the exhaust air channel contains a flexibly arranged and/or flexibly embodied guide element that is positioned on the grass surface. A seal usefully results with respect to the surface of the grassy area by means of the guide element that is arranged in the area of the bottom of the exhaust air channel and/or that forms the latter there, so that the air stream flowing through the free space reliably transports the sand, which is significantly heavier than the grass cuttings, and other foreign matter into the exhaust air channel. The inlet opening of the exhaust air channel with the aforesaid guide element is arranged in the direction of travel upstream of the nozzle of a inflow channel and advantageously has a significantly larger inlet surface than the outlet surface and/or the nozzle cross-section of the aforesaid nozzle.

Moreover, the weight distribution of the apparatus is advantageously pre-specified such that a rear roller, in the direction of travel, is significantly more loaded than a front roller. This weight distribution is caused in particular in that a drive motor and/or the fan are arranged in the rear part of the apparatus and/or in the area above and/or usefully also behind the rear roller. What this attains is that the grass and the layer of sand thereupon are only slightly loaded by the front roller, while the sand structure is highly densified by the rear roller and the surface of the grassy area is smoothed and/or advantageously rolled. Thus, there is no need for subsequent flat rolling of the grassy area, in particular the green on a golf course. It should in particular be noted that the nozzle and the guide element in the inlet area of the exhaust air channel and/or at least the rear roller extend largely across the entire width of the apparatus.

Special further developments and embodiments of the invention are provided in the following description.

The invention is explained in greater detail in the following using the exemplary embodiments depicted in the drawings without this resulting in a limitation.

### BRIEF DESCRIPTION OF THE DRAWINGS

FIG. 1 is a schematic side view and partial cut-away of the inventive apparatus;

FIG. 2 is another exemplary embodiment, depicted in a side view and partially cut away;

FIG. 3 is an enlargement of detail III in accordance with FIG. 2;

FIG. 4 provides a top view of the guide element comprising elastic plastic, in viewing direction IV in accordance with FIG. 3;

FIG. 5 is a schematic depiction and enlargement of a section in a vertical plane through the bottom of the grassy area;

FIG. 6 is a side view of a multiple arrangement having three apparatuses according to the invention; and

FIG. 7 is a top view of the multiple arrangement of FIG. 6.

### DETAILED DESCRIPTION OF THE INVENTION

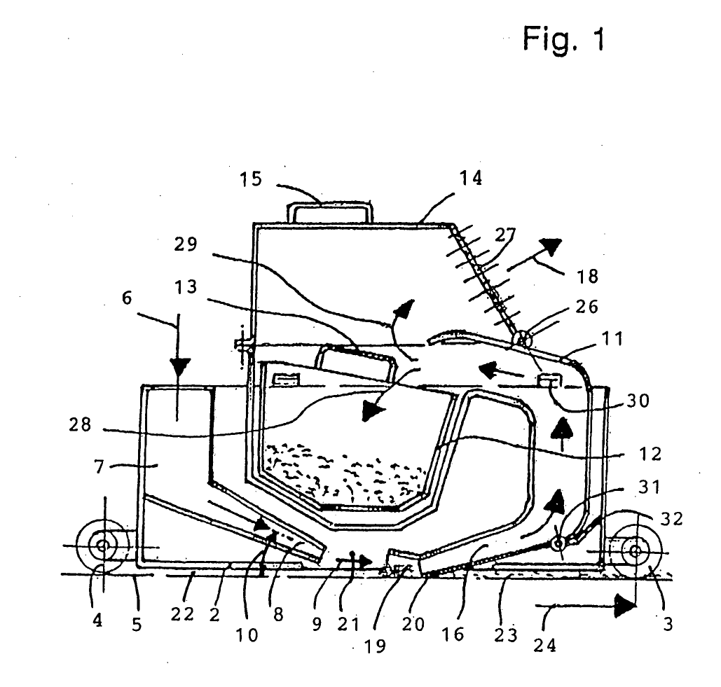

FIG. 1 depicts the apparatus with a basic housing 2 that has a width transverse to the plane of the drawing on the order of magnitude of 500 to 1000 mm, preferably 750 mm. The housing 2 possesses rollers 3, 4 by means of which the apparatus can be moved along on the ground or grassy area 5 indicated with the broken line. Provided in the housing 2 is a channel 7 having an inlet for the propelling air that is indicated with an arrow 6 and that opens into a nozzle 8. The propelling air is blown into the channel 7 by means of a fan (not shown) that is arranged above the inlet opening of the channel 7. The air flows out of the nozzle 8 as propelling air 9, passes over the grassy area 5 largely tangentially, and travels into the inlet opening of the exhaust air channel, that will be explained in the following. The nozzle 8 extends largely across the entire width of the housing 2 and is arranged at a pre-specified angle 10 to the ground or to the bottom of the housing 2. The aforesaid angle 10 advantageously ranges between 0° and 40°, usefully ranges between 5° and 35°, and in particular is on the order of magnitude of 10° to 30°. The apparatus, which for the sake of simplicity will hereinafter be called a “de-sander”, furthermore contains a receptacle housing 11 for the sand or debris, and furthermore provided in the receptacle housing 11 is a removable collection container 12 for the sand and/or debris. The receptacle housing 11 and, thus the collection container 12, which is provided with a handle 13, are closed at the top of the basic housing 2 by means of a pivotable cover 14 that can be pivoted up as needed for opening the receptacle housing 11 and for removing the collection container 12, the cover 14 usefully having a handle 15 for lifting it up.

Moreover, the de-sander, in particular the cover 14, contains an outlet for exhaust air 18. The de-sander, in particular its receptacle housing 11 or the basic housing 2, contain, in the area of the inlet opening 19 of the exhaust air channel 16, a guide element 20 that is embodied here as a guide sheet and over which the propelling air or the propelling stream 9 flows into the exhaust air channel 16. In the embodiment depicted, the guide sheet 20 is flexibly or pivotably attached, about an axis of rotation 31, to a fixing device 32, in particular the basic housing 2, by means of an articulation. A pre-specified free space 21 is disposed immediately above the ground or the grassy area 5 between the free end of the nozzle 8 and the guide sheet 20 of the exhaust air channel 16. The inlet opening of the exhaust air channel 16 is arranged at least approximately in the same horizontal plane as the nozzle 8. Thus, the propelling stream 9 exiting from the nozzle 8 flows over the grassy area 5 at a small angle and/or at least approximately tangentially and/or horizontally in the free space 21. The inlet surface of the exhaust air channel 16 is preferably larger than the outlet surface of the nozzle 8 by a pre-specified amount, preferably at least by a factor of 2. The nozzle 8 and the exhaust air channel 16 and its guide element 20 that is flexibly arranged and/or embodied and/or the in-flow opening of the exhaust air channel 16 extend largely and/or at least approximately across the entire width of the apparatus. Thus, in accordance with the invention, the excess sand 23 or other foreign material present on the grassy surface 22 is blown out by means of the propelling stream 9 or the air exiting from the nozzle 8 and is transported into the exhaust air channel 16 via the guide element or guide sheet 20.

The apparatus can be moved across the grassy area 5 in the working direction indicated by means of the arrow 24, whether manually or by means of a drive (not shown here) associated with the roller or rollers 4. The cover 14 can be pivoted by means of a joint about a point of rotation or axis of rotation 26 with respect to the basic housing 2, and the cover 14 furthermore contains outlet openings, in particular in the form of a perforated sheet 27, for the exhaust air 18. Due to gravity, the sand or other foreign material transported by means of the air falls downward into the collection container 12 according to the arrow 28 out of the air stream flowing past and above the collection container 12, and is segregated. As indicated with the arrow 29, the air then flows through the openings or the perforated sheet 27 of the cover 14 and flows to the outside as exhaust air 18.

The guide element or guide sheet 20 is a component of the exhaust air channel 16, the guide sheet 20 and/or the exhaust air channel 16 being pivotably borne about an axis of rotation 31 in the basic housing 2. The housing 2 contains the fixing device 32 for the joint or axis of rotation 31 for the guide sheet 20. Thus, it is assured in a particularly advantageous manner that the guide sheet 20 is disposed so that it floats on the grassy area and thus the sand is blown off of the grass by means of the propelling stream 9 and transported into the exhaust air channel 16 without the grassy area being damaged. It should be expressly noted that the attachment and/or fixing device 32 and/or the axis of rotation 31 are arranged in the working direction 24 upstream of the area of the guide element or guide sheet 20 on the grassy area 5, and thus the guide element or the guide sheet 20 is positioned free, in particular floating, on the grassy surface 5. The housing 2 usefully contains an end stop or a support below the guide sheet 20 such that if the apparatus moves counter to the working direction 24 the guide sheet 20 cannot penetrate too deep into the grassy area 5 in an impermissible manner. Moreover, it should be noted that the basic housing 2 is embodied open on the bottom in the area of the aforesaid free space 21 and/or in the area in which the propelling air nozzle 8 ends and the inlet area of the exhaust air channel 16 and the guide sheet 20 are present so that the propelling stream 9 can flow in the manner explained and that can be seen in the drawing largely and/or essentially horizontal in the free space 21 between the nozzle 8 and the inlet opening into the exhaust air channel 16 across the grass surface 22 for the purpose of removing excess sand or other foreign matter.

The receptacle housing 11 is fixed in the basic housing 2 by means of the bearing device 30. Thus, for cleaning or servicing it is simple to remove the receptacle housing 11 from the basic housing 2 with no problem. The handle 15, preferably arranged on the top of the cover 14, can be used to pivot the cover 14 up and also to lift and remove the receptacle housing 11 together with the cover 14 out of the basic housing 2. Moreover, the collection container 12 has the handle 13 in order to be able to lift the collection container 12 up and simply remove it for the purpose of emptying it when the cover 14 is open.

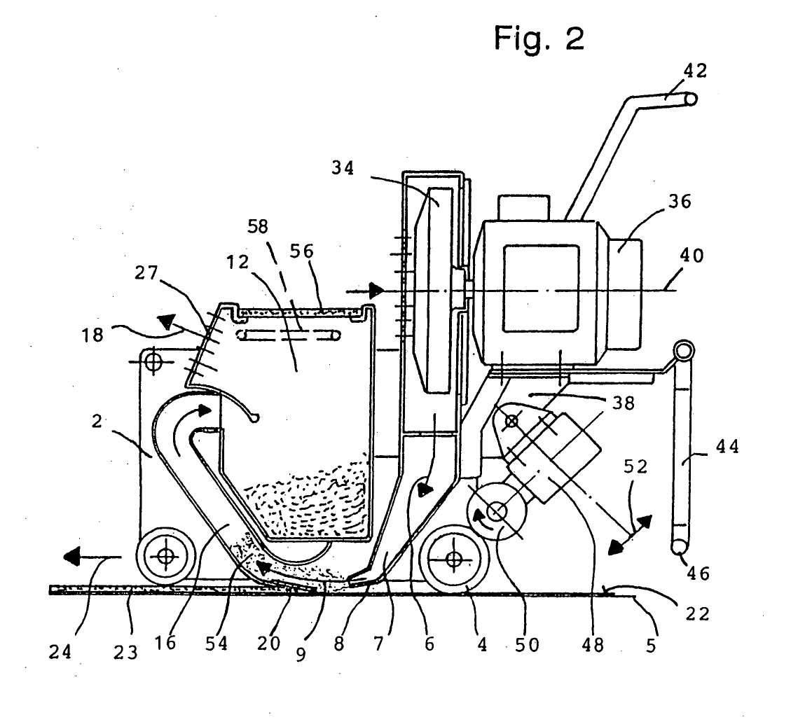

FIG. 2 depicts a special exemplary embodiment of the invention, in which the fan 34 arranged above the channel 7, omitted from FIG. 1, is now therein depicted. Provided for the fan 34 is a drive motor 36 that is arranged in the rear area of the apparatus and/or behind the fan 34 as seen from the direction of travel 24, and that is connected to the housing 2 by means of a support 38. The axis of rotation 40 of the drive motor 36 or its drive shaft for the fan 34 is usefully arranged largely horizontally. For producing the air stream, described in the foregoing, and removing in particular the layer of sand 23 from the lawn or the grassy area or the green, the apparatus contains the fan 34, which moves the propelling air 6 through the aforesaid channel 7 to the propelling air nozzle 8. As can be seen, the angled bar 42 is provided on the rear end of the basic housing 2 so that an operator can push and steer the apparatus. Furthermore, provided in the area of the bar 42 on the basic housing 2 is the drive motor 36, which is in particular embodied as a gas engine, but can just as well be embodied as an electric motor in the framework of the invention.

The fan 34 and the drive motor 36 are arranged in the rear end area of the apparatus and/or above the rear roller 4, so that the weight distribution is preferably such that the rear roller 4 is more heavily loaded than the front roller 3. At least the rear roller 4 is embodied as a cylinder roller and/or it extends largely across the entire width, specifically in accordance with the drawing transverse to the plane of the drawing, so that the grassy area or the ground 5 is smoothed or rolled in the same work step as the cleaning. A safety bar 44 is connected, in particular is pivotably connected, to the housing 2, in particular via the support 38. The lower end 46 of the safety bar 44 is disposed at a pre-specified height above the ground 5. The safety bar 44 provides support and/or prevents undesired tipping of the apparatus. The apparatus furthermore contains a usefully pivotable drive unit 48 having a drive roller 50. The drive unit 50 is provided for the apparatus travel mode and contains an electric motor or is coupled or can be coupled to the drive motor 36 or its drive shaft via a drive connection (not shown in greater detail) such as, for instance, a V-belt. For travel mode, the drive roller 48 is positioned against the rear roller 4, wherein due to the pivotable arrangement, adequate pressing force is provided in a simple manner for transmitting a driving torque onto the rear roller 4. As indicated with the double arrow 52, the drive unit 48 can be pivoted downward for travel mode as desired or can be pivoted upward for work mode.

The guide element 20 is usefully made of an elastic and/or flexible material, in particular plastic, and arranged in the area of the in-flow opening 19 of the bottom of the exhaust air channel 16. The elastically and/or flexibly embodied guide element 20 is preferably embodied as a guide comb unit and/or divided at its free ends by slits or the like transverse to the direction of travel 24, for attaining certain positioning and/or sealing in the downward direction with respect to the layer of sand. The propelling stream 9 thus passes over the guide element 20 and blows the sand layer out of the free space 21, so that it is blown as a sand/air mixture 54 through the exhaust air channel 16 into the collection container 12. The collection container 12 is covered on top by a transparent plate, in particular made of glass, so that it is easy to check the fill level of the collection container 12. The collection container 12 is detachably arranged immediately in the basic housing 2 and can be removed upward out of the housing as needed to be emptied. The collection container 12 usefully contains a handle 58 on both sides. In addition, see the information provided for FIG. 1 regarding the other components of this apparatus.

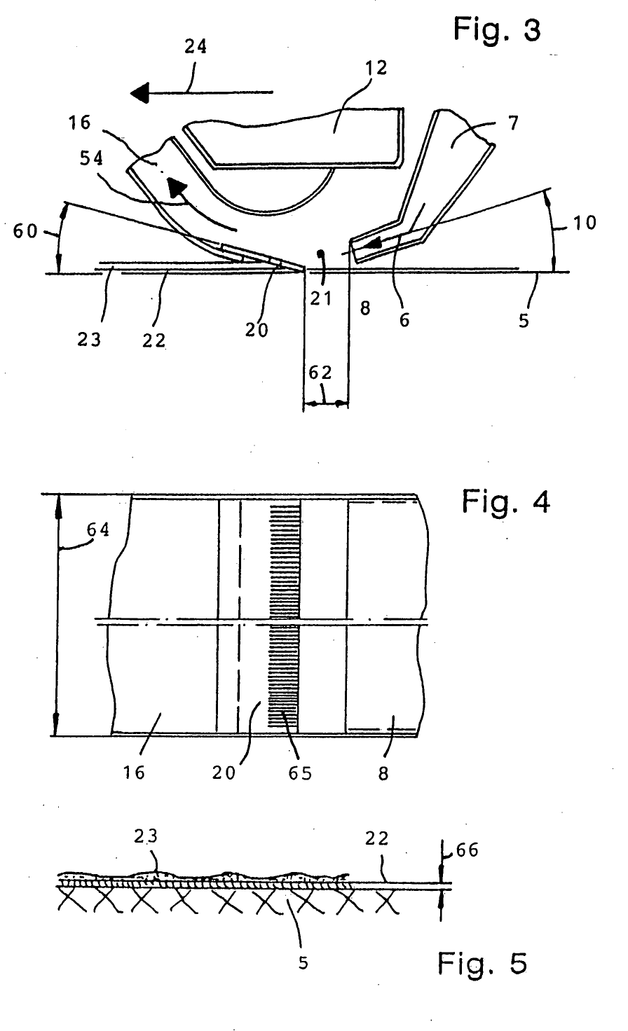

FIG. 3 is an enlargement of the detail II in FIG. 2 with the flexible guide element and/or guide comb unit 20, with slits running in opposition to the direction of work 24, that is arranged in the inlet area on the bottom of the exhaust air channel 16. As explained in the foregoing, the nozzle 8 is arranged inclined to the ground 5 at a pre-specified angle 10, ranging from 0° to 40°, the propelling air 9 being blown into the free space 21 at the aforesaid angle 10. The guide element 20 is arranged inclined to the ground 5 at another pre-specified angle 60, specifically opposing the inclination of the nozzle 8. The free end of the guide sheet 20 is positioned on the grass surface 22. The layer of sand 23 is disposed on the grass surface 22 in the working direction 24 in front of the nozzle 8 and/or the free space 21, while the layer of sand has been removed from the area of the grass surface over which the free space 21 has traveled and has been blown into the collection container 12 in the sand/air mixture in accordance with the arrow 54. The free space 21 has a length 62 in the working direction 24. This length usefully ranges from 10 to 150 mm.

FIG. 4 depicts a view in viewing direction IV according to FIG. 3 onto the flexible and/or elastic guide element 20 with the slits 65, and it is also possible to see the end of the nozzle 8 and the lower part of the exhaust air channel 16. The nozzle 8 and/or the exhaust air channel 16 and/or the guide element 20 have largely the same width 64. The width 64 is largely equal to the total width of the apparatus and/or of the housing and usefully ranges from 500 to 1000 mm.

FIG. 5 provides a schematic depiction in a vertical plane of a section through the ground 5 and the grass surface 22 in order to clarify relationships. The grassy area 5 or the grass has a height 66 that largely ranges between 2 and 6 mm. The layer of sand 23 that is to be removed by means of the apparatus according to the invention is disposed on the grass surface 22.

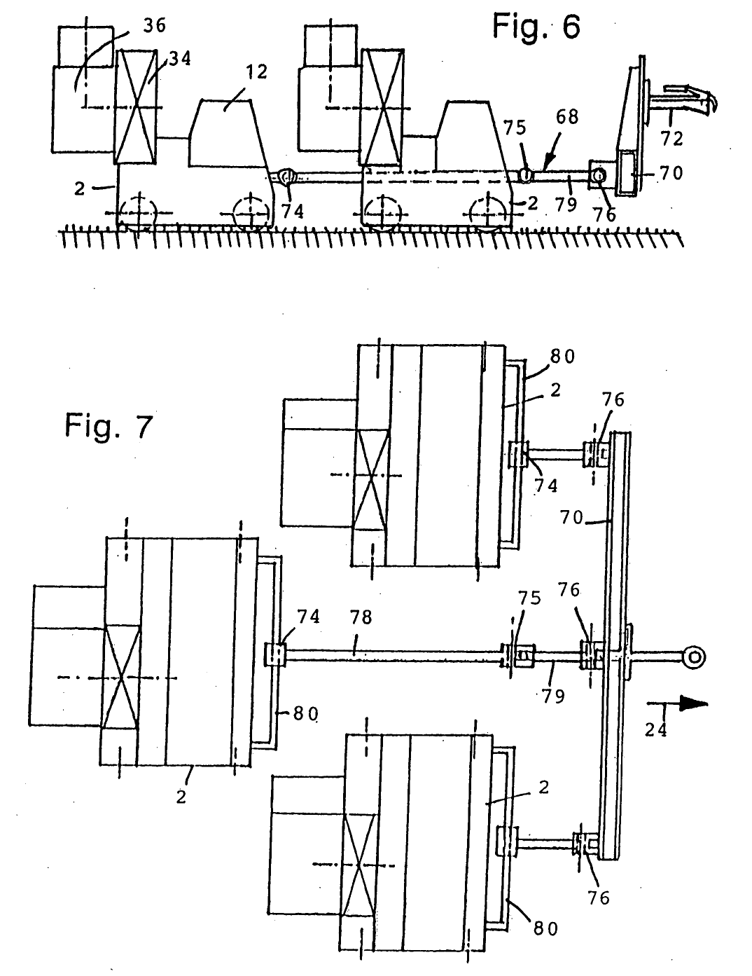

FIGS. 6 and 7 respectively provide a side view and a top view of a special further development of the invention, specifically in a multi-apparatus arrangement having three of the apparatus described in the foregoing, each of which contains the basic housing 2, the collection container 12, the fan 34, and the drive motor 36 of the fan. The apparatus or de-sanders are each connected in an articulated manner by means of connecting arrangements 68 to a common connector 70 that can be coupled to a transport vehicle by means of a coupling 72. The connecting arrangements 68 usefully contain articulations 74, 75, 76 and rods 78, 79 or the like that are connected thereto and that can be detached as needed. The de-sanders furthermore each contains bars 80, usefully arranged on the front of the basic housing 2, that extend across a majority of the total width of the respective de-sanders. As can be seen from FIG. 7, the three de-sanders are arranged in the direction of travel in accordance with arrow 24 behind one another and staggered with respect to one another such that sand and/or other foreign matter can be removed from the grassy surface without leaving stripes. In accordance with FIG. 7, two de-sanders are spaced apart from one another laterally and connected to the common connector 70 at a slight distance corresponding to the relatively short length of the rod 79, while the third, rear de-sander is coupled to the common connector 70 at a correspondingly longer distance therefrom in the “gap” between the two front de-sanders, specifically in the direction of travel 24 and “overlapping” with the two front de-sanders.

It is understood that in the framework of the invention a different number of de-sanders, for instance five de-sanders, can be connected in a corresponding manner to a pulling or pushing machine, such as a compact tractor or transport vehicle, so that a corresponding width of the grassy area can be cleaned in one work step. If five de-sanders are used, for instance, three de-sanders are provided advantageously in a front row spaced apart from one another and the two other de-sanders are provided in a rear row offset to them in the “gaps”.
2 Basic housing
3, 4 Roller
5 Ground/grassy area
6 Propelling air inlet
7 Channel
8 Nozzle
9 Propelling stream/air
10 Angle
11 Receptacle housing
12 Collection container
13 Handle for 12
14 Cover for 11
15 Handle for 14
16 Exhaust air channel
18 Exhaust air outlet
19 Inflow opening for 16
20 Guide element/guide sheet/guide comb unit for 16
21 Free space
22 Grass surface
23 Sand layer on lawn/grassy area
24 Working direction/arrow/direction of travel
26 Axis of rotation to 14
27 Opening/perforated sheet
28 Sand/arrow
29 Air/arrow
30 Bearing device for 11
31 Axis of rotation for 20
32 Fixing device for 20
34 Fan
36 Drive motor
38 Support for 36
40 Axis of rotation for 34, 36
42 Steering and/or operating bar
44 Safety bar
46 Lower end of 44
48 Drive unit
50 Drive roller
52 Double arrow
54 Sand/air mixture
56 Plate/glass plate
58 Handle for 12
60 Angle of 20
62 Length of 21
64 Width of 6, 16, 20
65 Slit
66 Height
68 Connecting arrangement
70 Connector
72 Coupling
73-76 Articulation
78, 79 Rod
80 Bar

1. An apparatus for cleaning a grassy by removing sand and or other debris therefrom, comprising:
a basic housing;
rollers;
a fan;
a collection container;
a nozzle being disposed downstream of a direction of flow of said fan through which propelled air conveyed by operation of said fan flows to said grassy area;
an exhaust air channel including an in-flow opening which is arranged downstream of said nozzle, while leaving a free space above said grassy area, such that the propelled air in said free space flows largely horizontally over said grassy area, is said exhaust air channel opening into said collection container for receiving the sand and/or other debris removed from said grassy area; and
a guide element being disposed in an area of said in-flow opening that can be positioned on said grassy area, said exhaust air channel opening into said collection container, for receiving the sand and/or debris removed from said grassy area, the apparatus including no cutting tool.

2. An apparatus according to claim 1, wherein said guide element is flexibly arranged or embodied.

3. An apparatus according to claim 1 further comprising a channel, said nozzle being arranged on the end of said channel, and said channel being connected at an other end thereof to said fan.

4. An apparatus according to claim 1 wherein said collection container is arranged either directly in said basic housing or in a receptacle housing of said basic housing and can be removed therefrom.

5. An apparatus according to claim 1, wherein said collection container and/or a cover arranged above said receptacle housing has openings.

6. An apparatus according to claim 1, wherein said free space is arranged beneath said receptacle housing and/or said collection container.

7. An apparatus according to claim 1, wherein said fan is arranged on the upper end of said basic housing.

8. An apparatus according to claim 1, wherein weight distribution is pre-specified such that said rear roller, in said working direction, is significantly more loaded than said front roller.

9. An arrangement having at least two apparatuses according to claim 1, wherein each of said apparatuses is connected in an articulated manner by a connecting arrangement to a common connector.

10. An arrangement according to claim 9, wherein each said connecting arrangement for each respective apparatus has at least one articulation and at least one rod.

11. An apparatus according to claim 1 wherein said guide element is embodied as a pivotably borne guide sheet

12. An apparatus according to claim 1 wherein said guide element comprises an elastic material.

13. An apparatus according to claim 12 wherein said elastic material is plastic.

14. An apparatus according to claim 1, wherein the free end of said guide element is positioned on said grassy area.

15. An apparatus according to claim 1 wherein said fan is arranged above said inlet opening of said channel.

16. An apparatus according to claim 1 wherein said receptacle housing is detachably arranged in said basic housing.

17. An apparatus according to claim 16, wherein said receptacle housing is detachably arranged by at least one bearing device.

18. An apparatus according to claim 5, wherein said cover is embodied as a perforated sheet for the exhaust air to exit.

19. An apparatus according to claim 1, wherein said cover is attached, pivotable about a preferably horizontally arranged axis

20. An apparatus according to claim 19, wherein said cover is pivotably attached to said receptacle housing.

21. An apparatus according to claim 1, wherein said fan is arranged, in the direction of travel, behind said cover and/or said collection container.

22. An apparatus according to claim 1, wherein said fan and a drive motor thereof are arranged largely in an area above said rear roller.

23. An apparatus according to claim 1, wherein said fan and a drive motor thereof are arranged at least in part offset further to a rear of said apparatus, in a working direction thereof.

24. An arrangement according to claim 9, wherein said common connector has a coupling for coupling to a transport vehicle.

25. An arrangement according to claim 9, wherein said apparatuses are offset and/or spaced apart from one another such that said grassy surface can be cleaned without leaving stripes

26. An apparatus according to 1, wherein an opening is present in said basic housing through which the propelling air is blown onto said grassy area, said opening being arranged beneath said receptacle housing and/or said collection container.
